(19) United States
(12) Patent Application Publication
(10) Pub. No.: US 2021/0274267 A1
(43) Pub. Date: Sep. 2, 2021

(54) COMMUNICATION SYSTEM, MANAGEMENT SERVER, HOT WATER SYSTEM, HOT WATER FACILITY AND RELAY DEVICE

(71) Applicant: NORITZ CORPORATION, HYOGO (JP)

(72) Inventors: Naoki TAWADA, Akashi-shi, Hyogo (JP); Masaharu UCHIKURA, Akashi-shi, Hyogo (JP); Takahito HASHIMOTO, Hyogo (JP); Hiroshi TOSAKI, Hyogo (JP)

(73) Assignee: NORITZ CORPORATION, HYOGO (JP)

(21) Appl. No.: 17/052,807

(22) PCT Filed: May 22, 2019
(86) PCT No.: PCT/JP2019/020242

§ 371 Date: Nov. 4, 2020

(30) Foreign Application Priority Data
Jul. 18, 2018 (JP) 2018-134943

(51) Int. Cl. H04Q 9/00; F24H 9/20

(52) U.S. Cl. CPC H04Q 9/00; H04L 67/12; F24H 9/2007

(57) ABSTRACT

In a communication system, a management server stores information about a hot water systems for each hot water system on the basis of individual identification information, and stores the individual identification information of a plurality of identification target machines for each hot water system. When the individual identification information of the plurality of identification target machines is received from a relay device, the management server collates the received individual identification information with the stored individual identification information. When at least one of the received individual identification information matches the stored individual identification information as a result of the collation, if all the individual identification information stored for the hot water system which has the identification target machine with the matching individual identification information includes individual identification information different from the received individual identification information, the management server rewrites the different individual identification information to the received individual identification information.

### BACKGROUND

### Technical Field

The present invention relates to a communication system which remotely monitors a hot water facility such as a water heater by a management server.

### Related Art

Conventionally, there is a communication system which remotely monitors a hot water facility such as a water heater via a communication network by a management server. For example, patent literatures 1 and 2 disclose a communication system having a configuration in which a plurality of water heaters are connected and operated as the hot water facility.

In the communication system that remotely monitors the hot water facility, a hot water system in which a relay device (for example, also referred to as a communication adapter) is connected to the hot water facility is included, and information about the hot water system is transmitted from the relay device to a management server via a communication network such as the Internet.

### LITERATURE OF RELATED ART

### Patent Literature

Patent literature 1: Japanese Patent Laid-open No. 2017-58026

Patent literature 2: Japanese Patent Laid-open No. 2017-62054

### SUMMARY

### Problems to be Solved

In the communication system described above, the management server recognizes and manages the hot water system on the basis of individual identification information (for example, the manufacturing number) of the relay device. That is, the information about the hot water system is stored in association with the individual identification information of the relay device. Therefore, for example, when the relay device fails and is replaced with a new relay device, because the individual identification information of the relay device before and after replacement is different, the management server recognizes that a new hot water system has been arranged, and the information about the hot water system acquired form the relay device before replacement cannot be taken over and managed even though the user is the same.

The present invention has been made to solve the above problems, and an objective of the present invention is to provide a communication system that can, even when a relay device is replaced, take over and manage information about the hot water system before the replacement of the relay device.

### Means to Solve the Problems

In order to achieve the above objective, a communication system according to an aspect of the present invention includes: a plurality of hot water systems which include a hot water facility configured by one or more machines, and a relay device which is a machine communicating with the hot water facility and connectable to a communication network; and a management server that communicates with the relay device via the communication network. At least one of the one or more machines and the relay device are configured as identification target machines having individual identification information. For each of the hot water systems, the management server stores information about the hot water system transmitted from the relay device via the communication network together with the individual identification information of the relay device on the basis of the individual identification information of the relay device, and stores the individual identification information of the plurality of identification target machines transmitted from the relay device via the communication network. When the individual identification information of the plurality of identification target machines is received from the relay device, the management server collates the received individual identification information with the stored individual identification information. When at least one piece of the received individual identification information matches the stored individual identification information as a result of the collation, if all the individual identification information stored for the hot water system which has the identification target machine with the matching individual identification information includes individual identification information different from the received individual identification information, the management server rewrites the different individual identification information to the received individual identification information.

According to the configuration, the management server stores, for each hot water system, individual identification information of a plurality of identification target machines included in the hot water system. When the individual identification information of the plurality of identification target machines of the hot water system is received, the management server collates the received individual identification information with the stored individual identification information. When at least one piece of the received individual identification information matches the stored individual identification information as a result of the collation, if all the individual identification information stored for the hot water system which has the identification target machine with the matching individual identification information includes individual identification information different from the received individual identification information, the management server rewrites the different individual identification information to the received individual identification information. Thereby, in a certain hot water system, for example, when the relay device is replaced, the management server rewrites the individual identification information of the relay device before replacement of the hot water system to the individual identification information of the relay device after replacement. Thus, after the relay device is replaced, similar to the information about the hot water system transmitted from the relay device together with the individual identification information of the relay device before replacement, the information about the hot water system transmitted from the relay device together with the individual identification information of the relay device after replacement is stored as information about the same hot water system. That is, even when the relay device is replaced, it is possible to take over and manage the information about the hot water system before the replacement of the relay device.

When at least one piece of the received individual identification information matches the stored individual identification information as a result of the collation, if there is missing individual identification information in the received individual identification information as for all the individual identification information stored for the hot water system which has the identification target machine with the matching individual identification information, the management server may transmit the individual identification information to the relay device in order to add individual identification information to the identification target machine corresponding to the missing individual identification information.

According to the configuration, when a part of a certain identification target machine is replaced and the individual identification information of this identification target machine is missing, the management server transmits the individual identification information (for example, the individual identification information stored by the management server before missing) to add individual identification information to the identification target machine, and thereby the identification target machine can acquire the individual identification information.

In addition, a management server according to an aspect of the present invention is the management server used in the above communication system.

In addition, a hot water system according to an aspect of the present invention is the hot water system used in the above communication system.

In addition, a hot water facility according to an aspect of the present invention is the hot water facility used in the above communication system.

In addition, a relay device according to an aspect of the present invention is the relay device used in the above communication system.

### Effect

The present invention can provide a communication system which has the configuration described above and can, even when a relay device is replaced, take over and manage information about a hot water system before the replacement of the relay device.

### BRIEF DESCRIPTION OF THE DRAWINGS

FIG. 1 is a schematic configuration diagram showing an example of a communication system of the embodiment.

FIG. 2 is a flowchart showing an example of the operation of a management server when a plurality of individual identification information of a hot water system is received.

FIG. 3 is a diagram showing another example of the hot water system.

### DESCRIPTION OF THE EMBODIMENTS

Hereinafter, preferred embodiments are described with reference to the drawings. Moreover, in the following description, the same or corresponding elements are denoted by the same reference numerals throughout the drawings, and redundant description thereof is omitted. In addition, the present invention is not limited to the following embodiments.

### Embodiment

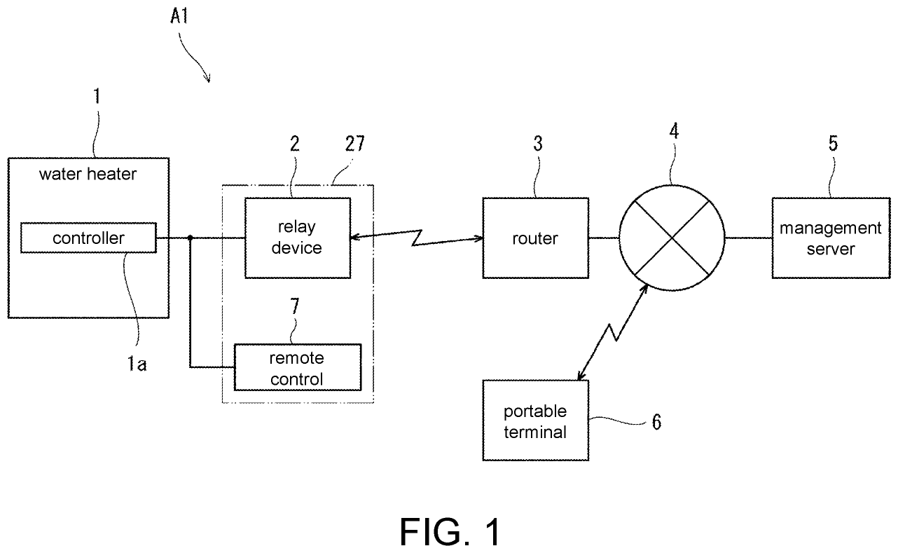

FIG. 1 is a schematic configuration diagram showing an example of a communication system of the embodiment. The communication system of the embodiment includes a hot water system A1 and a management server 5 that has a computer connected to a communication network 4 such as the Internet.

The hot water system A1 includes a water heater 1 that is an example of a hot water facility, a relay device 2 which is exclusive for the water heater and is communicably connected to a controller 1a built-in the water heater 1, and a remote control (remote controller) 7 for remotely operating the water heater 1. The controller 1a of the water heater 1, the remote control 7, and the relay device 2 are configured to be communicable with each other.

The water heater 1 is arranged on a predetermined place inside or outside a house, is a combustion-heating-type water heater (heat source machine) for example, and has a hot water supply function of supplying hot water to a kitchen or a bathtub, and the like. The controller 1a which is built in the water heater 1 includes, for example, a microcontroller which has a CPU and a memory (RAM, ROM, and the like), and the like, and controls an operation of the entire water heater 1.

The remote control 7 includes an operation unit and a display unit (not shown). A user can operate the operation unit to perform driving of the water heater 1, setting of a hot water supply temperature, or the like, and can display the driving state of the water heater 1, the setting temperature of the hot water supply temperature or the like on the display unit. Moreover, a plurality of remote controls 7 may be arranged.

The relay device 2 performs connection setting between a router 3 and a wireless LAN, and can wirelessly communicate with the router 3 by the wireless LAN. The relay device 2 executes communication processing with the controller 1a of the water heater 1 and the remote control 7, and also executes communication processing with the management server 5 performed via the router 3 and the communication network 4.

Here, the router 3 is a wireless LAN router owned by the user of the hot water system A1, and wirelessly communicates with the relay device 2, but the router 3 may be connected to the relay device 2 in a wired manner to communicate with the relay device 2.

The management server 5 communicates with the relay device 2 via the communication network 4 and the router 3 which is connected to the communication network 4. The management server 5 stores information transmitted from the controller 1a of the water heater 1 via the relay device 2 as necessary. Moreover, the management server 5 may include a plurality of computers which are connected to the communication network 4. That is, the management server 5 may include a plurality of servers which share and execute the function of the management server 5.

A portable terminal 6 includes a smartphone or the like owned by the user of the hot water system A1, and can mutually communicate with the management server 5 via the communication network 4 or the like. An application program exclusive for the hot water system (hereinafter, referred to as “system exclusive application”) is installed in the portable terminal 6, and the user can operate the portable terminal 6 to activate the system exclusive application and perform remote operation and state confirmation of the water heater 1 or the like via the management server 5 and the like. The portable terminal 6 includes a display unit composed of a display with a touch panel, an operation unit composed of the touch panel, a sound output unit having a speaker, and the like.

As described above, the communication system utilizes the communication network 4, the router 3, and the portable terminal 6. In the communication system, there may be one house in which the hot water system A1 is arranged, but there are usually a large number of houses. Here, only one hot water system A1 is illustrated as a representative, and the router 3 and the portable terminal 6 corresponding to the hot water system A1 are illustrated.

In the communication system, the information (machine information) transmitted from the controller 1a of the water heater 1 to the management server 5 via the relay device 2 includes facility configuration information transmitted from the controller 1a of the water heater 1 to the relay device 2 immediately after power activation, driving state information showing the driving state of the water heater 1 and transmitted from the controller 1a of the water heater 1 to the relay device 2 periodically (for example, at one-hour intervals), error information, and the like. Here, the facility configuration information is information showing the type and the like of the water heater 1, and the driving state information is information including the setting temperature of hot water supply, the number of times of combustion driving, the combustion driving time and the like of the water heater 1. The error information is information showing an abnormality when the abnormality occurs in the water heater 1 and the like, and is information also displayed on the remote control 7. These pieces of machine information described above are transmitted from the relay device 2 to the management server 5 together with the individual identification information of the relay device 2 (machine information transmission processing of the hot water system A1 executed by the relay device 2).

In the management server 5, the corresponding hot water system A1 is specified from the individual identification information of the relay device 2, and the received information is stored in a storage unit in association with the identification information of the hot water system A1. Moreover, the identification information of the hot water system is information (for example, serial number) arbitrarily determined by the management server 5 in order to identify each of the plurality of hot water systems. In addition, as described later, the identification information of the hot water system is stored in the management server 5 in association with individual identification information of a plurality of identification target machines that include the relay device of the hot water system. Thus, as described above, the corresponding hot water system A1 can be specified from the individual identification information of the relay device 2.

In addition, the relay device 2 transmits individual identification information of a plurality of predetermined machines (hereinafter, also referred to as “identification target machines”) among machines that configure the hot water system A1 to the management server 5. In the case of the hot water system A1, for example, the relay device 2, the water heater 1, and the remote control 7 can be set as the identification target machines. Here, the relay device 2 is necessarily included in the plurality of identification target machines. In addition, either the water heater 1 or the remote control 7 may not be included in the identification target machine.

Each identification target machine previously stores the individual identification information. The individual identification information may be any information as long as the information is uniquely assigned to each identification target machine, and for example, a manufacturing number, a MAC address and the like can be used therefor.

In the hot water system A1, when the water heater 1, the relay device 2, and the remote control 7 are set as the identification target machines, the relay device 2 receives individual identification information of the water heater 1 from the controller 1a and receives individual identification information of the remote control 7 from the remote control 7, and then transmits each of the individual identification information of the water heater 1 and the remote control 7 to the management server 5 together with the individual identification information of itself (relay device 2). The management server 5 stores the individual identification information of the plurality of identification target machines for each hot water system. That is, the management server 5 stores, for each hot water system of a plurality of users, the individual identification information of the plurality of predetermined identification target machines among the machines that configure the hot water system in association with the identification information of the hot water system.

In this way, the individual identification information of the plurality of identification target machines including the relay device 2 may be, for example, transmitted to the management server 5 together with the facility configuration information transmitted immediately after the water heater 1 is turned on every time. In addition, the individual identification information may be transmitted periodically.

As described above, the management server 5 is configured to store, for each hot water system of the plurality of users, the individual identification information of a plurality of identification target machines that configure the hot water system, the facility configuration information showing the type and the like of the hot water facility (for example, the water heater 1) of the hot water system, the driving state information of the hot water facility of the hot water system, the error information, and the like in association with the identification information of the hot water system.

In addition, the management server 5 also stores user association information in order to make it possible that the user operates the portable terminal 6 to perform remote operation and state confirmation of the water heater 1. The user association information is, for example, information in which the identification information of the hot water system A1 and a user account transmitted previously from the portable terminal 6 of the user of the hot water system A1 are associated with each other.

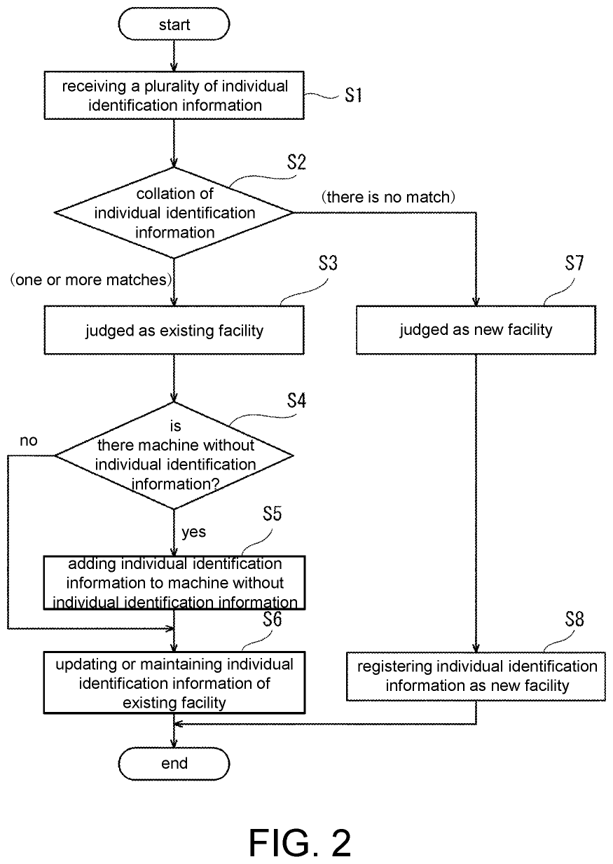

FIG. 2 is a flowchart showing an example of the operation of the management server 5 when the individual identification information of the plurality of identification target machines which are transmitted from the relay device 2 of the hot water system A1 at a predetermined timing (a plurality of individual identification information of the hot water system A1) is received. Moreover, for example, when the water heater 1 is turned on, the relay device 2 performs the processing (individual identification information transmission processing for the hot water system A1) for receiving individual identification information from identification target machines other than the relay device 2, and then transmitting the received individual identification information to the management server 5 together with the individual identification information of the relay device 2.

By the individual identification information transmission processing for the hot water system A1 performed by the relay device 2, the management server 5 receives the plurality of individual identification information of the hot water system A1 from the relay device 2 in step S1, and then collates the plurality of received individual identification information with the plurality of stored individual identification information of each hot water system in step S2.

When all the received individual identification information is different from all the stored individual identification information (when there is no match) as a result of the collation, it is judged that the hot water system A1 of transmission source is a new facility (new hot water system) (step S7); the identification information of the hot water system A1 is determined arbitrarily, and the identification information and all the received individual identification information are stored (registered) in association with each other (step S8). Thereby, it is possible to store, in association with the identification information of the new facility (hot water system A1), other information (information about the hot water system A1 such as facility configuration information, driving state information, error information and the like) of the new facility. That is, the management server 5 stores the information about the hot water system A1 for each hot water system A1. The information about the hot water system A1 is mainly information about the hot water facility (water heater 1 in the example).

In addition, when one or more pieces of the received individual identification information match the stored individual identification information of the hot water system A1 as the result of the collation in step S2, it is judged that the transmission source is an existing facility (hot water system A1) having a machine with the matching individual identification information (step S3).

Next, in step S4, it is judged whether or not there is a machine without individual identification information (a machine that has not received individual identification information) among the identification target machines included in the existing hot water system A1. Here, normally, there is no machine without individual identification information. However, for example, when a control board is replaced to repair a failed machine, the individual identification information (for example, the manufacturing number of the machine) is stored in the control board before replacement (control board during the shipment of the machine), but the individual identification information is not stored in the control board after replacement. In this case, the machine has no individual identification information. In step S4, if the number of the individual identification information received in step S1 is less than the number of the individual identification information stored for the hot water system A1, the management server 5 judges that there is a machine without individual identification information and proceeds to step S5. If the number of the individual identification information received in step S1 is the same as the number of the individual identification information stored for the hot water system A1, the management server 5 judges that there is no machine without individual identification information and proceeds to step S6.

When there is a machine without individual identification information in step S4, individual identification information is added to the machine without individual identification information (step S5). In step S5, the management server 5 selects individual identification information that is not included in the individual identification information received in step S1 from the plurality of stored individual identification information of the hot water system A1, and the management server 5 transmits, in order to add the selected individual identification information (missing individual identification information) to the machine without individual identification information, the selected individual identification information to the relay device 2 of the hot water system A1 as the individual identification information of the machine.

For example, when the control board of the controller 1a of the water heater 1 is replaced and the water heater 1 becomes the machine without individual identification information, the stored individual identification information of the water heater 1 is transmitted from the management server 5 to the controller 1a via the relay device 2, and then the controller 1a stores the transmitted individual identification information as the individual identification information of itself (water heater 1).

In step S6 following step S5 in this case, the management server 5 maintains the individual identification information stored for the hot water system A1 (that is, doing nothing).

In addition, when there is no machine without individual identification information in step S4, there are a case in which all the received individual identification information matches all the individual identification information stored for the hot water system A1, and a case in which one or more pieces of the received individual identification information are different from the individual identification information stored for the hot water system A1 (one or more pieces of the individual identification information are matching). When all the individual identification information is matching, in step S6, the management server 5 maintains the individual identification information stored for the hot water system A1 (that is, doing nothing).

On the other hand, when one or more individual identification information is different, in step S6, the management server 5 rewrites (updates) the individual identification information among the individual identification information stored for the hot water system A1, which is different from the received individual identification information, to the received individual identification information. This is the case in which any one of the recognition target machines is replaced with a new machine in the hot water system A1.

As described above, in the embodiment, the management server 5 stores the identification information of each of the plurality of hot water systems in association with the individual identification information of the plurality of identification target machines including the relay device of the hot water system. When the individual identification information of the plurality of identification target machines including the relay device 2 is received from the relay device 2 of the hot water system A1, if one or more pieces of the received individual identification information match the stored individual identification information of the identification target machine of the hot water system A1, and if all the individual identification information stored for the hot water system A1 includes individual identification information different from the received individual identification information, the management server 5 rewrites the different individual identification information to the received individual identification information. Thereby, in the hot water system A1, when the relay device 2 is replaced, the management server 5 rewrites the individual identification information of the relay device 2 before replacement, which is associated with the identification information of the hot water system A1, to the individual identification information of the relay device 2 after replacement. Thus, after the relay device 2 is replaced, similar to the information transmitted from the relay device 2 together with the individual identification information of the relay device 2 before replacement, the information transmitted from the relay device 2 together with the individual identification information of the relay device 2 after replacement is stored as the information about the same hot water system A1 in association with the identification information of the same hot water system A1. That is, even when the relay device 2 is replaced, it is possible to take over and manage the information about the hot water system A1 before the replacement of the relay device 2.

Moreover, although not shown, a monitoring terminal arranged in a call center for performing error check, service arrangement or the like of the hot water system A1, and a communication terminal carried by a maintenance supplier are connected to the communication network 4. By displaying the model name and software version of each component machine of the designated hot water system A1 on each of the terminals, maintenance information (materials or replacement parts required for maintenance) can be easily grasped. In addition, for each component machine, appropriate information can be displayed as other items. For example, in the case of a water heater, by displaying information about the total combustion driving time or the total heat supply, it is possible to match with the model name to grasp that the failure time is approaching, and it is possible to provide various services to the user of the hot water system A1. In the grasp of the maintenance information or the service to the user, even when the relay device 2 is replaced as described above, it is possible to provide useful information by taking over and managing the information about the hot water system A1 before the replacement of the relay device 2.

In addition, in order to make it possible that the user operates the portable terminal 6 to perform the remote operation and the state confirmation of the water heater 1, the management server 5 stores the user association information in which the identification information of the hot water system A1 and the user account are associated with each other.

When the user uses the portable terminal 6 to remotely operate the water heater 1, the user operates the portable terminal 6 to activate the system exclusive application, logs in to a user management site provided by the management server 5, and transmits remote operation information (command) for remotely operating the water heater 1 to the management server 5. Then, the management server 5 refers to the user association information including the user account acquired at the time of login, and transmits the remote operation information to the relay device 2 of the hot water system A1 having the identification information which is included in the user association information. Thereby, the remote operation information is transmitted to the controller 1a via the relay device 2, and the controller 1a controls the water heater 1 on the basis of the received remote operation information. As the remote operation information, there are a driving start command, a driving stop command, setting information of the hot water temperature and the like of the water heater 1.

In addition, when the user uses the portable terminal 6 to confirm the state of the water heater 1, the user operates the portable terminal 6 to activate the system exclusive application, logs in to the user management site provided by the management server 5, and transmits machine state request information for requesting the state information of the water heater 1 to the management server 5. Then, the management server 5 refers to the user association information including the user account acquired at the time of login, and transmits, to the portable terminal 6, machine state information among the information about the hot water system A1 stored in association with the identification information of the hot water system A1 which is included in the user association information. Here, the machine state information is information which includes the above driving state information, and for example, the machine state information may be configured by only the driving state information, or may be configured by the driving state information and the error information.

As described above, because the user association information is information in which the identification information of the hot water system A1 and the user account are associated with each other, even when the relay device 2 is replaced and thereby the individual identification information of the relay device 2 has changed, the identification information of the hot water system A1 does not change, and thus it is possible to perform the remote operation and the state confirmation of the water heater 1 by using the portable terminal 6.

Moreover, in the hot water system A1 of FIG. 1, the relay device 2 and the remote control 7 are individually configured, but the relay device 2 and the remote control 7 also may be integrally configured as a relay device with built-in remote control 27 composed of a single machine (identification target machine).

In addition, as the hot water facility which configures the hot water system A1, the water heater 1 has been taken as an example, but the hot water facility is not limited hereto and may be a bath reheating device, a hot water heating heat source machine, or a heat source machine having two or more functions of hot water supply function, bath reheating function and hot water heating function, and may be additionally a filtration device for filtering hot water in a bathtub or the like.

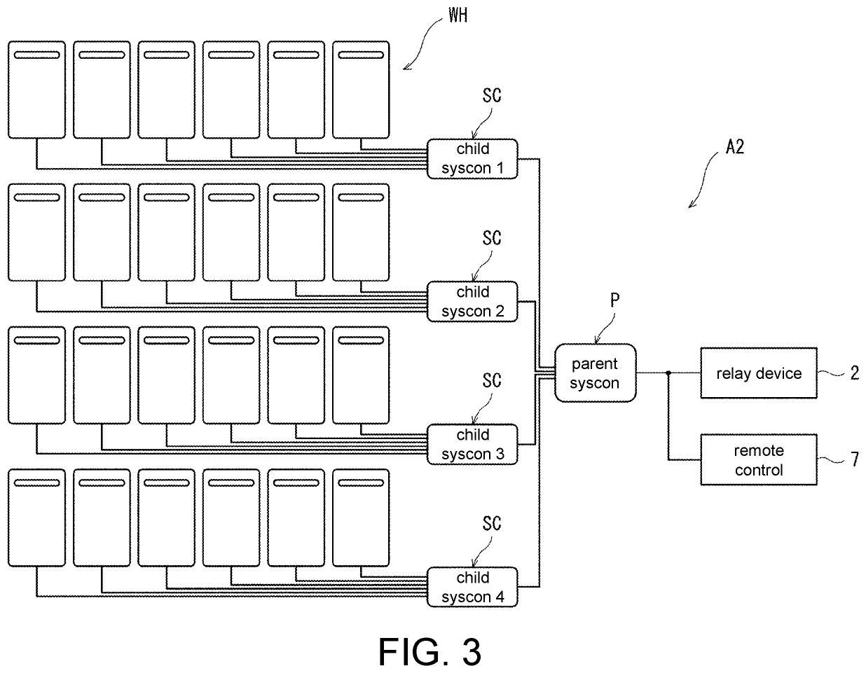

In addition, the hot water facility which configures the hot water system A1 has a configuration in which a plurality of water heaters are connected, and may be configured in a manner that the number of the driving water heaters increases or decreases according to an increase or decrease in the hot water supply amount. An example of the above case is shown in FIG. 3.

A hot water system A2 shown in FIG. 3 is a hot water system for business arranged in a certain facility, and includes, as the hot water facility, a system controller P in the top level (hereinafter, referred to as “parent syscon P”), four system controllers SC in the bottom level (hereinafter, referred to as “child syscon SC”) which are connected in parallel to the lower hierarchy of the parent syscon P, and a total of 24 water heaters WH in which every six water heaters WH are connected to the lower hierarchy of each child syscon SC, and the number of the driving water heaters WH is controlled by the parent syscon P and the child syscon SC. The control content of the number of the driving water heaters WH performed by the parent syscon P and the child syscon SC is not specifically limited, and the number of the driving water heaters WH is controlled to increase or decrease according to the increase or decrease in the hot water supply amount. Moreover, the number of the connected child syscons SC and the number of the connected water heaters WH can be changed according to the maximum hot water supply capacity required in the arranged facility. In addition, if the number of the arranged water heaters WH is six or less, the parent syscon P may not be arranged, and the number of the driving water heaters WH may be controlled by only one child syscon SC.

In the case of the hot water system A2, the identification target machine can be the relay device 2 and each water heater WH. In addition, the parent syscon P, each child syscon SC, and the remote control 7 may also be added to the identification target machine.

From the above description, many improvements or other embodiments of the present invention are apparent to those skilled in the art. Therefore, the above description should be construed as illustrative only and is provided for the purpose of teaching those skilled in the art the best aspect for carrying out the present invention. Details of the structure and/or the function may be changed substantially without departing from the spirit of the present invention.

### INDUSTRIAL APPLICABILITY

The present invention is useful as a communication system or the like that can, even when a relay device is replaced, take over and manage information about a hot water system before the replacement of the relay device.

### REFERENCE SIGNS LIST

A1, A2 hot water system
1, WH water heater
2 relay device
3 router
4 communication network
5 management server
6 portable terminal
7 remote control
27 relay device with built-in remote control

1. A communication system, comprising:
a plurality of hot water systems which comprise a hot water facility configured by one or more machines, and a relay device which is a machine communicating with the hot water facility and connectable to a communication network; and
a management server that communicates with the relay device via the communication network,
wherein at least one of the one or more machines and the relay device are configured as identification target machines having individual identification information,
wherein the management server is configured to:
store, for each of the hot water systems, information about the hot water systems transmitted from the relay device via the communication network together with the individual identification information of the relay device, on the basis of the individual identification information of the relay device;
store, for each of the hot water systems, the individual identification information of the plurality of identification target machines transmitted from the relay device via the communication network; and
collate the received individual identification information with the stored individual identification information when the individual identification information of the plurality of identification target machines is received from the relay device, when at least one piece of the received individual identification information matches the stored individual identification information as a result of the collation, rewrite the different individual identification information to the received individual identification information if all the individual identification information stored for the hot water system which has the identification target machine with the matching individual identification information includes individual identification information different from the received individual identification information.

2. The communication system according to claim 1, wherein the management server is configured to:
when at least one piece of the received individual identification information matches the stored individual identification information as a result of the collation, if there is missing individual identification information in the received individual identification information as for all the individual identification information stored for the hot water system which has the identification target machine with the matching individual identification information, transmit the individual identification information to the relay device in order to add individual identification information to the identification target machine corresponding to the missing individual identification information.

3. A management server, which is used in the communication system according to claim 1.

4. A hot water system, which is used in the communication system according to claim 1.

5. A hot water facility, which is used in the communication system according to claim 1.

6. A relay device, which is used in the communication system according to claim 1.
